(19) United States
(12) Patent Application Publication
(10) Pub. No.: US 2012/0014295 A1
(43) Pub. Date: Jan. 19, 2012

(54) ELECTRONIC DEVICE, STORAGE MEDIUM STORING INFORMATION PROCESSING PROGRAM AND INFORMATION PROCESSING METHOD

(75) Inventors: Naotaka Yasuda, Osaka (JP); Naoki Mochizuki, Osaka (JP)

(73) Assignee: KYOCERA CORPORATION, Kyoto (JP)

(21) Appl. No.: 13/257,835

(22) PCT Filed: Mar. 5, 2010
(86) PCT No.: PCT/JP2010/053623

§ 371 Date: Sep. 20, 2011

(30) Foreign Application Priority Data
Mar. 26, 2009 (JP) 2009-075423

(51) Int. Cl. H04W 4/12; H04W 88/02

(52) U.S. Cl. 370/271; 370/259

(57) ABSTRACT

A mobile phone apparatus (10) includes a CPU (12), and when starting to record a PTT communication, the CPU (12) records voice data corresponding to a voice of a speaker in a flash memory (18). Furthermore, the CPU (12) records the identifying information of the speaker, a starting time of a speech and an ending time of the speech as an index in the flash memory (18) while recording the voice data. In all speaker reproduction, the voice data recorded in the flash memory (18) is reproduced from the top, and identifying information of the speaker that is being reproduced is displayed on the LCD monitor (30) according to the index. Alternatively, in selected speaker reproduction, only the voice data of the speaker selected by the use is reproduced according to the index, and the identifying information of the speaker that is being reproduced is displayed on the LCD monitor (30).

### TECHNICAL FIELD

The present invention relates to an electronic device, a storage medium storing an information processing program and an information processing method. More specifically, the present invention relates to an electronic device, a storage medium storing an information processing program and an information processing method that make communications with other electronic devices.

### BACKGROUND ART

One example of an electronic device of such a kind is disclosed in a Patent Document 1. In the Patent Document 1, an electronic conferencing system of performing an electronic conferencing by a half-duplex communication by connecting a plurality of communication terminals and an electronic conferencing server is disclosed. In the electronic conferencing utilizing the electronic conferencing system, as well as a communication only by a voice communication, a response to a speaker is searched in real time by questionnaires, or data transfer of the associated information is performed. In the communication terminal of the electronic conferencing system, various information, such as received or input letters, images, voices, sounds, and video images, etc. can be stored.

Furthermore, another example of the electronic device of such a kind is disclosed in a Patent Document 2. A digital sound recording and reproducing apparatus of the Patent Document 2 performs a control of recording sound data input from a microphone in a recording medium with an index mark for identifying the content of the data recorded, and reproducing the sound data recorded in the recording medium in a file unit at random.

Patent Document 1: Japanese Patent Application Laid-Open No. 2007-49424 [H04Q 7/38, H04M 3/56, H04L 12/18, G06F 13/00]

Patent Document 2: Japanese Patent Laid-open No. 9-259595 [G11C 27/00, G10L 9/18]

### SUMMARY OF THE INVENTION

### Problems to be Solved by the Invention

However, in the communication terminal of the Patent Document 1, the voice in the half-duplex communication can be stored, but speeches (voices) of a plurality of speakers are recorded (stored) in chronological order, that is, voices of a plurality of speakers are mixed, and therefore, it is difficult to specify a speaker from the result of the recording. As the number of speakers is great, this problem is more noticeable.

Thereupon, like the digital sound recording and reproducing apparatus of the Patent Document 2, recording the index mark is conceivable, but an operation of recording the index mark is needed, so that it is troublesome. Furthermore, if such an operation is missed, it is difficult to specify a speaker similar to the Patent Document 1.

Therefore, it is a primary object of the present invention to provide a novel electronic device, a novel storage medium storing an information processing program and a novel information processing method.

Another object of the present invention is to provide an electronic device, a storage medium storing an information processing program and an information processing method capable of easily identifying when and from whom a series of recorded contents comes from.

### Means for Solving the Problems

The present invention employs following features in order to solve the above-described problems. It should be noted that reference numerals inside the parentheses and the supplementary explanations show one example of a corresponding relationship with the embodiments described later for easy understanding of the present invention, and do not limit the present invention.

A first invention is an electronic device making a half-duplex communication among one or a plurality of communication partner's devices, comprising: a communicator which sends and receives a content to and from the communication partner's device, and an information storage which stores the content, identifying information about a sender of the content and a sent time in a storage when the content is sent to the communication partner's device by the communicator, and stores the content, identifying information about a sender of the content and a received time in the storage when the content is received from the communication partner's device by the communicator.

In the first invention, an electronic device (10) makes a half-duplex communication among one or a plurality of communication partner's devices (10). A communicator (12, 28, S7, S11) sends and receives a content to and from the communication partner's device. An information storage (12, S1, S9, S13, S25) stores the content, identifying information about a sender of the content and a sent time in a storage (14, 18) when the content is sent to the communication partner's device by the communicator. Furthermore, the information storage stores the content, identifying information about a sender of the content and a received time in the storage when the content is received from the communication partner's device by the communicator.

According to the first invention, the information in relation to the sender of the content and the sent time or the received time are recorded as well as the content, and therefore, it is possible to easily know when and from whom the series of contents comes from.

A second invention is according to the first invention, further comprising: a displayer; a content reproducer which reproduces a content stored in the storage; and an identifying information displayer which displays identifying information about at least the sender of the content on the displayer when the content is reproduced by the content reproducer.

In the second invention, an electronic device is provided with a displayer (30). A content reproducer (12, 26, 34, S53, S109) reproduces a content stored in the storage. At this time, an identifying information displayer (12, S65, S107) displays identifying information about at least the sender of the content on the displayer.

According to the second invention, when the content is reproduced, the identifying information about the sender of the content is displayed on the displayer, and therefore, it is possible to easily know from whom the content that is being reproduced comes from.

A third invention is according to the second invention, wherein the content reproducer reproduces contents stored in the storage according to a temporal order of the sent time and the received time.

In the third invention, the content reproducer reproduces contents stored in the storage according to a temporal order of the sent time and the received time. That is, a series of contents is reproduced in chronological order.

According to the third invention, the series of contents is reproduced in chronological order, and therefore, it is possible to easily know a flow of the communication.

A fourth invention is according to the second invention, further comprising: an identifying information selector which selects the identifying information about the sender of the content, wherein the content reproducer reproduces the content stored in the storage together with the identifying information about the sender of the content selected by the identifying information selector.

In the fourth invention, an identifying information selector (12, 20) selects the identifying information about the sender of the content. For example, one or a plurality of identifying information about the sender of the content are selected according to an operation by the user. The content reproducer reproduces the content stored in the storage together with the identifying information about the sender of the content selected.

According to the fourth invention, the content stored together with the identifying information about the selected sender is reproduced, and therefore, it is possible to reproduce only the content from the specific sender.

A fifth invention is according to the first invention, wherein the identifying information about the sender of the content is a phone number.

In the fifth invention, the electronic device is a mobile phone apparatus, and the information about the sender of the content is the phone number, for example.

According to the fifth invention, the phone number is used as information about the sender of the content, and therefore, it is possible to know from whom the content comes from directly from the phone number or indirectly by an address book, a phone book, etc.

A sixth invention is according to the first invention, wherein the information storage stores the identifying information about the sender of the content and the sent time or the received time that are stored together with the content as an index file including them in the storage.

In the sixth invention, the information storage stores the identifying information about the sender of the content and the sent time or the received time as an index file (52) including them.

According to the sixth invention, by referring the index file, the reproduction processing as described above can be implemented.

A seventh invention is according to the first invention, wherein the information storage stores the identifying information about the sender of the content and the sent time or the received time that are stored together with the content as header information of the content.

In the seventh invention, the information storage stores the identifying information about the sender of the content and the sent time or the received time that are stored together with the content as header information of the content.

According to the seventh invention, by referring to the header information of the content, the reproduction processing as described above can be implemented.

An eighth invention is according to the first invention, wherein the sent time and the received time are an absolute time from a start of recording the content.

In the eighth invention, the sent time and the received time are an absolute time from a start of recording the content.

According to the eighth invention, the sent time and the received time are the absolute time from start of recording the content, and therefore, it is possible to easily take synchronization between the reproduction of the content and the sent time or the received time.

A ninth invention is a storage medium storing an information processing program of an electronic device making a half-duplex communication among one or a plurality of communication partner's devices, the information processing program causes a computer of the electronic device to execute: a communicating step for sending and receiving a content to and from the communication partner's device, and an information storing step for storing the content, identifying information about a sender of the content and a sent time in a storage when the content is sent to the communication partner's device by the communicating step, and storing the content, identifying information about a sender of the content and a received time in the storage when the content is received from the communication partner's device by the communicating step.

In the ninth invention as well, similar to the first invention, it is possible to easily determine when and from whom the series of recorded contents comes from.

A tenth invention is an information processing method of an electronic device making a half-duplex communication among one or a plurality of communication partner's devices, including steps of: (a) sending and receiving a content to and from the communication partner's device, and (b) storing the content, identifying information about a sender of the content and a sent time in a storage when the content is sent to the communication partner's device by the step (a), and storing the content, identifying information about a sender of the content and a received time in the storage when the content is received from the communication partner's device by the step (a).

In the tenth invention as well, similar to the first invention, it is possible to easily determine when and from whom the series of recorded contents comes from.

According to the present invention, in a case that the content is sent and received, the information about the sender of the content, the sent time or the received time of the content are recorded, and therefore, it is possible to easily determine when and from whom the series of recorded contents comes from.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an electric configuration of a mobile phone apparatus of one embodiment of this invention.

FIG. 2 is an illustrative view showing an appearance of the mobile phone apparatus shown in FIG. 1.

FIG. 3 is an illustrative view showing one example of a PTT communication system by utilizing the mobile phone apparatus shown in FIG. 1.

FIG. 4 is an illustrative view showing one example of a voice file and an index file stored in a flash memory shown in FIG. 1.

FIG. 5 is an illustrative view showing one example of a screen to be displayed on an LCD monitor shown in FIG. 1.

FIG. 6 is an illustrative view showing one example of a memory map of a RAM shown in FIG. 1.

FIG. 7 is a flowchart showing a part of PTT communication recording processing by the CPU shown in FIG. 1.

FIG. 8 is a flowchart showing another part of the PTT communication recording processing by the CPU shown in FIG. 1.

FIG. 9 is a flowchart showing all speaker reproducing processing by the CPU shown in FIG. 1.

FIG. 10 is a flowchart showing a part of selected speaker reproducing processing by the CPU shown in FIG. 1.

FIG. 11 is a flowchart showing another part of the selected speaker reproducing processing by the CPU shown in FIG. 1.

### FORMS FOR EMBODYING THE INVENTION

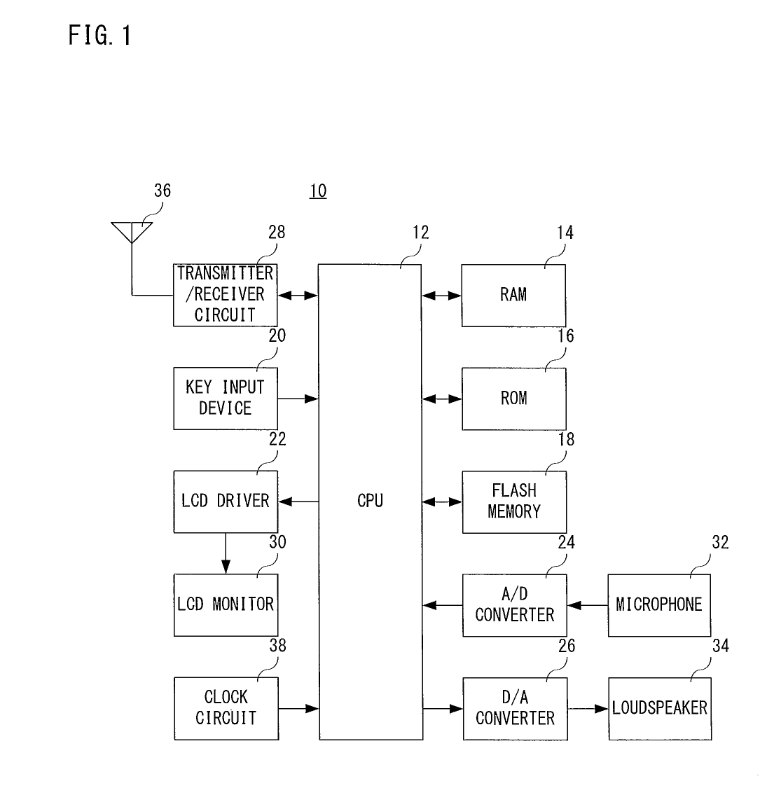

Referring to FIG. 1, a mobile phone apparatus 10 as an electronic device of this embodiment includes a CPU 12. The CPU 12 is connected with a RAM 14, a ROM 16, a flash memory 18, a key input device 20, an LCD driver 22, an A/D converter 24, a D/A converter 26, a transmitter/receiver circuit 28 and a clock circuit 38 via a bus. Furthermore, to the LCD driver 22, an LCD monitor 30 is connected. To the A/D converter 24, a microphone 32 is connected, and to the D/A converter 26, a loudspeaker 34 is connected via an amplifier (not illustrated). Then, to the transmitter/receiver circuit 28, an antenna 36 is connected.

The CPU 12 entirely controls the mobile phone apparatus 10. The RAM 14 is utilized as a work area or a buffer area of the CPU 12. The ROM 16 is an electrically rewritable memory, such as an EEPROM, for example, and stores various programs to be executed by the CPU 12 and various data to be utilized by these programs. The flash memory 18 records data of contents, such as letters, images, voices, sounds and video images other than data, such as a profile of an owner of the mobile phone apparatus 10, an address book, a schedule book, etc.

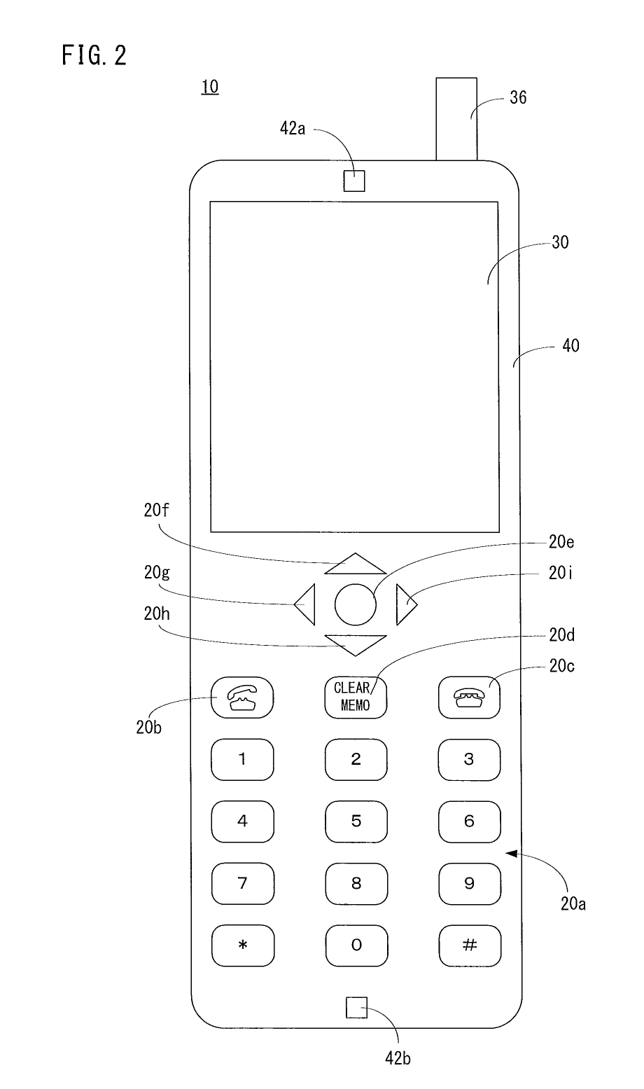

The key input device 20 is provided with a plurality of keys, such as dial key 20a (see FIG. 2), etc. including “0” to “9” keys, a “*” key and a “#” key by which information of a key (key data) operated by a user is input to the CPU 12. The LCD driver 22 controls the display of the LCD monitor 30 connected to the LCD driver 22 under the instruction of the CPU 12.

The A/D converter 24 converts an analogue voice signal relative to a voice or a sound input through the microphone 32 connected to the A/D converter 24 into a digital voice signal. The D/A converter 26 converts (decodes) a digital voice signal read from the flash memory 18 into an analogue voice signal, and applies it to the loudspeaker 34 via the amplifier. Accordingly, a voice or a sound corresponding to the analogue voice signal is output from the loudspeaker 34.

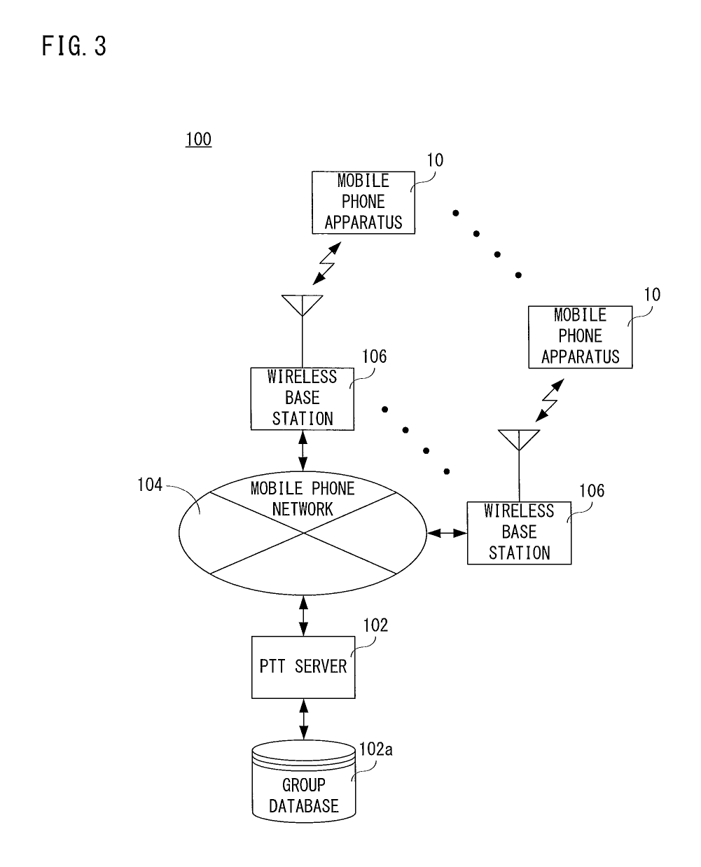

The transmitter/receiver circuit 28 is a circuit for performing a wireless communication in a CDMA (Code Division Multiple Access) system, for example For example, when the user designates a calling by using the key input device 20, the transmitter/receiver circuit 28 executes a calling operation under the instruction of the CPU 12, and outputs a calling signal via the antenna 36. The calling signal is sent to a telephone apparatus of a communication partner through base stations and a communication network (see FIG. 3). Then, when a called operation is performed in the telephone apparatus of the communication partner, a connected state (communication allowable state) is established, and the CPU 12 executes talk communication processing (hereinafter referred to as “normal talk communication processing” for the sake of convenience of description).

When the normal talk communication processing is described in detail, a modulated voice signal (high frequency signal) sent from the telephone apparatus of the communication partner is received by the antenna 36. Demodulation processing and decode processing are given to the received modulated voice signal by the transmitter/receiver circuit 28. The received voice signal acquired by such processing is converted into an analogue voice signal by the D/A converter 26, and is output from the loudspeaker 34. On the other hand, a voice signal to be sent input through the microphone 32 is converted into a digital voice signal by the A/D converter 24, and the resultant digital signal is applied to the CPU 12. Encoding processing and modulation processing are given to the voice signal to be sent which is converted into the digital voice signal by the transmitter/receiver circuit 28 under the instruction of the CPU 12, and the processed digital voice signal is output via the antenna 36. Accordingly, the modulated voice signal is sent to the telephone apparatus of the communication partner via the base stations and the communication network.

Furthermore, when a calling signal from the telephone apparatus of the communication partner is received by the antenna 36, the transmitter/receiver circuit 28 notifies the CPU 12 of an incoming call (called). In response thereto, the CPU 12 controls the LCD driver 22 to thereby display calling source information (phone number or name of the sender or both of them) described in the incoming call notification on the LCD monitor 30. Furthermore, at the same time or approximately the same time, the CPU 12 outputs an incoming call tone (or incoming call melody or ringtone) from a incoming call notifying speaker (not shown). When the user designates an incoming call by using the key input device 20, the transmitter/receiver circuit 28 executes an incoming call operation under the instruction of the CPU 12 to establish a connected state (communication allowable state), and the CPU 12 executes the above-described normal talk communication processing.

In addition, the CPU 12 acquires at least a current time from the clock circuit 38 such as an RTC. For example, the CPU 12 controls the LCD driver 22 to display the current time on the LCD monitor 30 as described above (clock display).

FIG. 2 is an external view of the mobile phone apparatus 10 shown in FIG. 1. Referring to FIG. 2, the mobile phone apparatus 10 has a case (housing) 40 in the form of plate. The case 40 is provided with the above-described LCD monitor 30 so as to expose the display surface thereof. As understood from FIG. 2, the display surface of the LCD monitor 30 has a size covering approximately the upper half of the case 40. Furthermore, below the LCD monitor 30, the key input device 20 is arranged such that a push portion (operating portion) of each of the keys is exposed from the case 40. In this embodiment, the key input device 20 is made up of a dial key 20a, an off-hook key 20b, an on-hook key 20c, a clear/memo key 20d, a center key 20e, an upward key 20f, a leftward key 20g, a downward key 20h and a rightward key 20i.

Here, the arrangement and design of each of the keys 20a-20i need not be restricted to that shown in FIG. 2, and may arbitrarily be set. Furthermore, the number of keys may be increased or decreased in correspondence with the function of the mobile phone apparatus 20.

Furthermore, as shown in FIG. 2, the above-described antenna 36 is provided to the case 40 such that a part of it is protruded from the upper end. In addition, as shown in FIG. 2, the case 40 is provided with a hole 42a and a hole 42b at upper and lower ends respectively on a surface on which the display surface of the LCD monitor 30 and the push portions of the key input device 20 are provided. Although illustration is omitted, in correspondence with the position where the hole 42a is provided, the above-described loudspeaker 34 is provided inside the case 40. Although illustration is omitted, in correspondence with the position where the hole 42b is provided, the above-described microphone 32 is provided inside the case 40. Accordingly, the user can hear a voice (sound) output from the loudspeaker 34, and input his or her own speech (comment) to the microphone 32.

One example of a PTT (Push-To-Talk) communication system (hereinafter simply referred to as “system”) 100 by using such a mobile phone apparatus 10 is shown in FIG. 3. As shown in FIG. 3, the system 100 includes a PTT server 102, and the PTT server 102 has a function of managing the mobile phone apparatus 10 that requests a PTT communication and a mobile phone apparatus 10 being a communication partner of the PTT communication, and intermediating PTT communications among a plurality of mobile phone apparatuses 10. The PTT server 102 is connected with a plurality of wireless base stations 106 via the mobile phone network (network) 104. In addition, the system 100 includes a plurality of mobile phone apparatuses 10, and each mobile phone apparatus 10 performs a communication with another mobile phone apparatus 10 via the mobile phone network 104 and the wireless base station 106 (PTT communication processing).

When there is a request of a PTT communication from a certain mobile phone apparatus 10 to the PTT server 102, the PTT server 102 first performs intermediate processing for the PTT communication. Here, the request of the PTT communication includes this being the PTT communication and identifying information of a desired communication partner for the PTT communication, that is, another mobile phone apparatus 10. In this embodiment, the identifying information is a phone number of the mobile phone apparatus 10. Here, in place of the phone number, this may be information (information for specifying the mobile phone apparatus 10 other than the phone number) equivalent to the phone number.

When receiving the request of the PTT communication, the PTT server 102 performs a call (PTT call) for the PTT communication on another mobile phone apparatus 10 (of the communication partner). When there is a notification of participation from the other mobile phone apparatus 10 to the PTT server 102 in response thereto, the mobile phone apparatus 10 from which there is a request of the PTT communication and the mobile phone apparatus 10 from which there is a notification of the participation are set as a group for performing a current PTT communication. That is, the PTT server 102 groups a plurality of mobile phone apparatuses 10 which make the PTT communication, and registers the group in a group database (group DB) 102a. Then, the PTT server 102 establishes a connected state with each of the mobile phone apparatus 10 from which there is a request of the PTT communication and the mobile phone apparatus 10 from which there is a notification of the participation. In what follows, the PTT server 102 performs PTT communication processing aimed at only the grouped mobile phone apparatuses 10.

Although a description in detail is omitted here, when the PTT communication is ended, the group registered in the group DB 102a is erased.

For example, when a speech request is issued from a certain mobile phone apparatus 10 in the group for the PTT communication in response to a push of the PTT button (off-hook key 20b in this embodiment), the PTT server 102 gives a right to speak to the certain mobile phone apparatus 10 in response thereto if there is no mobile phone apparatus 10 which is making a speech. In accordance with the acquisition of the right to speak, the voice data of the user (speaker) of the certain mobile phone apparatus 10 is converted into packet data by the CPU 12 of this mobile phone apparatus 10, and the voice data converted into a packet (voice packet) is output via the transmitter/receiver circuit 28 and antenna 36. The voice packet output from the mobile phone apparatus 10 is sent to the PTT server 102 via the wireless base station 106 and the mobile phone network 104. Here, the identifying information, etc. of the sender (the mobile phone apparatus 10 of the speaker) is added to the voice packet as a header. When receiving the voice packet, the PTT server 102 sends the voice packet to all the other mobile phone apparatuses 10 registered as a group via the mobile phone network 104 and the wireless base station 106 with reference to the group DB 102a. When each of the mobile phone apparatuses 10 receives the voice packet from the PTT server 102 through the antenna 36 and the transmitter/receiver circuit 28, it restores the data converted into a packet to the original voice data by the CPU 12. Then, the voice data is converted into an analogue voice signal by the D/A converter 26, and a voice corresponding to the analogue voice signal is output from the loudspeaker 34.

Here, when there is a speech request from the mobile phone apparatus 10, in a case that there is another mobile phone apparatus 10 which is making a speech, the PTT server 102 sends back a response of denial to the mobile phone apparatus 10 from which the speech request is issued. Furthermore, in a case that there are speech requests from a plurality of mobile phone apparatuses 10, the PTT server 102 decides a priority of the respective mobile phone apparatuses 10 according to a predetermined rule, and gives a right to speak in order based on it. Example is that a high priority is given in the order in which the number of speeches is less, or a high priority is given in the order in which the number of denials to the speech request is more, as a predetermined rule.

Furthermore, in the mobile phone apparatus 10, by using a function of communicated voice memo, the voices in the aforementioned PTT communication can be recorded. For example, when the user pushes the clear/memo key 20d of the key input device 20 during the PTT communication, PTT communication recording processing is started. Accordingly, the voices of the speaker are recorded.

Normally, in a case that the voices during the PTT communication are recorded, the speeches (comments) of a plurality of speakers are recorded in chronological order. Accordingly, in a case that the recorded contents are reproduced, the speeches of the plurality of speakers are reproduced in turn in chronological order.

However, because the speeches (voices) of the plurality of speakers are mixed, it is difficult to specify a speaker. The greater the number of the speakers (participants of the PTT communication) is, the more the problem is noticeable. Furthermore, even if only the speech of the specific speaker is desired to be heard, all the speeches are required to be heard, resulting in troublesome as well as useless time.

Thereupon, in this embodiment, in a case that speeches during the PTT communication are recorded, identifying information of a speaker, a starting time of the speech and an ending time of the speech are stored together with the voice data in correspondence with each of the speeches.

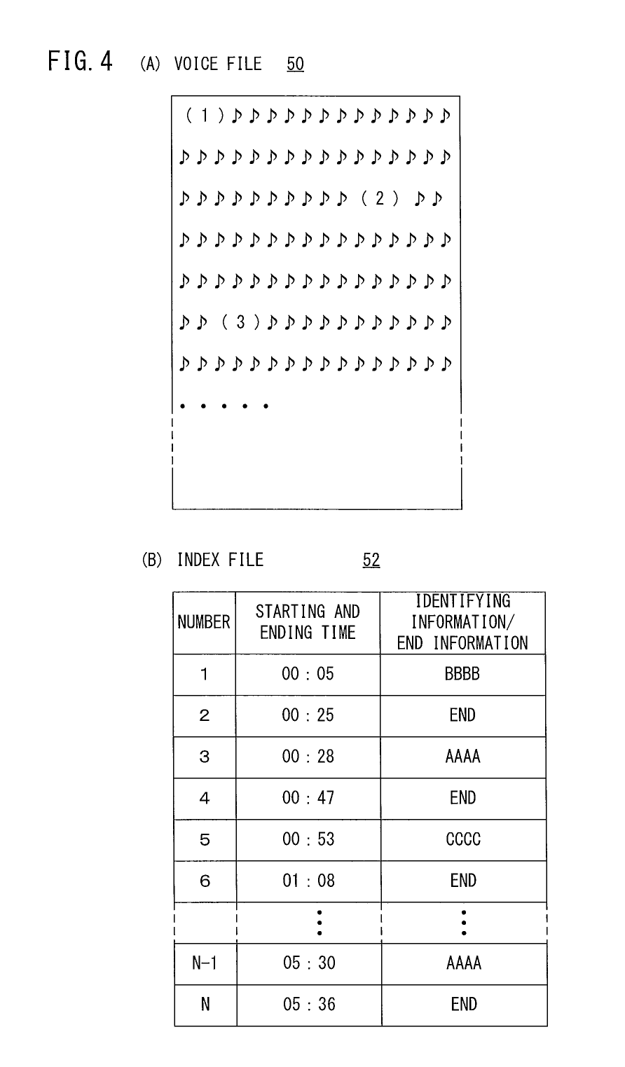

More specifically, together with a voice file 50 as shown in FIG. 4(A), an index file 52 as shown in FIG. 4(B) is stored in the flash memory 18. The voice file 50 is a data file in which voice data corresponding to the speeches during the PTT communication is recorded in chronological order. For example, the voice data is recorded in an AAC (Advanced Audio Coding) format. In a case that a voice to be input to the mobile phone apparatus 10 is recorded, an analogue voice signal input through the microphone 32 is converted into a digital voice signal by the A/D converter 24. Then, the digital voice signal is converted into the AAC format by the CPU 12, and recorded in the flash memory 18.

On the other hand, the voice packet sent from the PTT server 102 is received through the antenna 36 and the transmitter/receiver circuit 28, and applied to the CPU 12. The received voice packet is restored to the original voice data by the CPU 12 which is converted into the AAC format, and stored in the flash memory 18.

Here, the PTT communication is being executed, and therefore, the above-described PTT communication processing is also executed at the same time as the voice data recording processing.

The index file 52 is a data file of a table in which a starting time and an ending time being a sent time or a received time of the speech corresponding to the voice data, and identifying information of the speaker or end information of the speech are recorded.

As a starting time and an ending time of the speech, an absolute time from the start of the PTT communication is recorded. Here, in a case that the speech of the user of the mobile phone apparatus 10 (hereinafter referred to as “own machine”) is to be sent, the starting time of the speech is the absolute time when the PTT button (off-hook key 20b) is pushed, and the ending time of the speech is the absolute time when the PTT button is released. On the other hand, in a case that the speech of the user of another mobile phone apparatus 10 (hereinafter referred to as “other machine”) is to be received, the starting time of the speech is the absolute time when the reception of the voice packet is started, and the ending time of the speech is the absolute time when the output of the voice corresponding to the voice data which is restored from the voice packet is entirely completed.

Furthermore, as identifying information, the phone number of the mobile phone apparatus 10 owned by the speaker is recorded. Here, in FIG. 4(B), for simplicity, the identifying information (phone number) is represented by four alphabetic characters. Here, the identifying information of the own machine is described in the ROM 16, and the identifying information of the other machine is described in a header of a voice packet sent from the PTT server 102. As end information, a content indicating that the speech is ended (“END” in this embodiment) is recorded.

Accordingly, with reference to the first line of the index file 52, that is, the index number (1), it is found that the starting time of the speech is 00 minutes 5 seconds (00:05), and the speaker is the user of the mobile phone apparatus 10 indicated by the phone number “BBBB”. Furthermore, with reference to the second line of the index file 52, that is, the index number (2), it is found that the ending time of the speech of the user of the mobile phone apparatus 10 indicated by the phone number “BBBB” is 00 minutes 25 seconds (00:25).

Although a detailed description is omitted, this holds true for another number (3), (4), . . . , (N).

Additionally, in FIG. 4, the voice data is stored from the top of the voice file 50 in chronological order. For example, in correspondence with the voice data indicated by (1) in FIG. 4(A), the indexes indicated by the index numbers (1), (2) in FIG. 4(B) are described, and in correspondence with the voice data indicated by (2) in FIG. 4(A), the indexes indicated by the index numbers (3), (4) in FIG. 4(B) are described.

Thus, as well as the voice file 50, the index file 52 corresponding thereto is recorded (created), and therefore, only the voice by the selected speaker can be reproduced as well as all the recorded speeches (voices) can be reproduced. Furthermore, at reproduction, the identifying information of the speaker of the speech is informed during reproducing, capable of easily knowing the speaker.

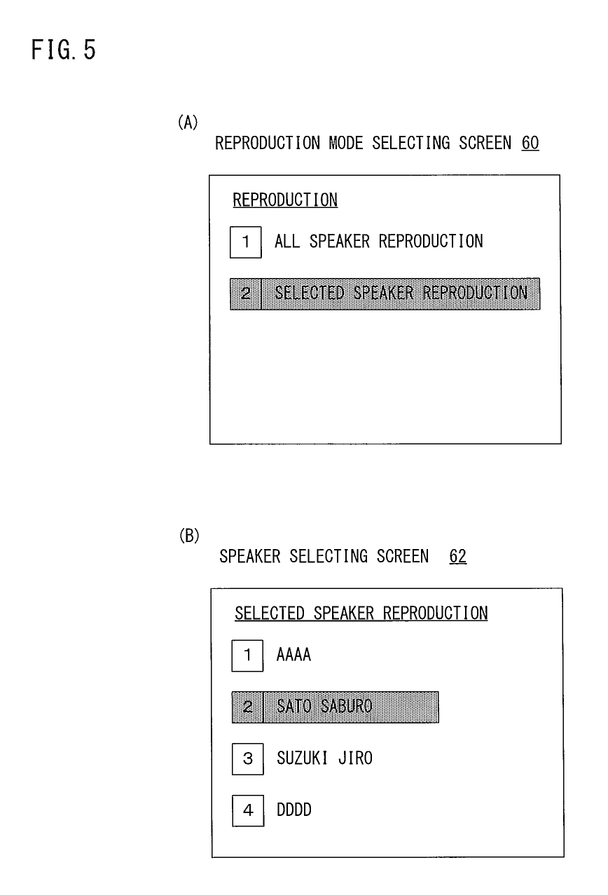

For example, when reproducing the communicated voice memo is selected on the menu selecting screen not shown, a reproduction mode selecting screen 60 as shown in FIG. 5(A) is displayed on the LCD monitor 30. On the reproduction mode selecting screen 60, two reproduction menus (all speaker reproduction, selected speaker reproduction) are selectively displayed. Here, in FIG. 5(A) (this holds true for FIG. 5(B)), for the sake of simplicity, a cursor is shown by a solid filled rectangle.

A user operates the upward key 20f or the downward key 20h to move the cursor up or down, and puts the cursor on a desired menu. Then, the user operates the center key 20e to select (decide) a desired menu. Here, when the “all speaker reproduction” is selected, the voice data of the voice file 50 recorded in the flash memory 18 is reproduced from the top.

In addition, when the “selected speaker reproduction” is selected on the reproduction mode selecting screen 60, a speaker selecting screen 62 is displayed on the LCD monitor 30 as shown in FIG. 5(B). Here, it is possible to select one or a plurality of speakers. Although a description in detail is omitted, the phone numbers of the user of the own machine and the user of the other machine registered as a communication partner of the PTT communication are displayed on the speaker selecting screen 62. Here, as understood from FIG. 5(B), in the mobile phone apparatus 10, as to the user of the own machine whose designation (name, nickname, etc.) is registered in the profile and the user of the other machine whose designation is registered in correspondence with the phone number in the address book and the phone book, the designations thereof are displayed.

Here, as to the user who does not belong to the current PTT communication group, the designation need not be displayed on the speaker selecting screen 62, or grayed out so as not to be selected.

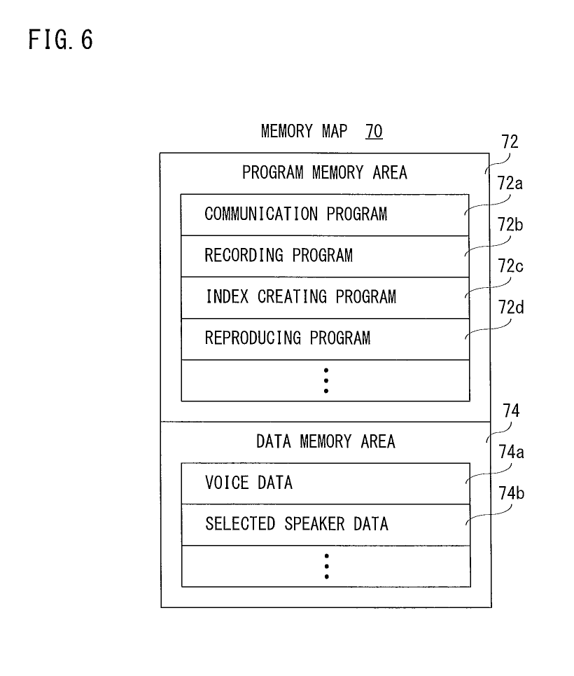

FIG. 6 is a memory map 70 of the RAM 14 shown in FIG. 1. As shown in FIG. 6, the RAM 14 includes a program memory area 72 and a data memory area 74. The program memory area 72 stores information processing program, and the information processing program is made up of a communication program 72a, a recording program 72b, an index creating program 72c, a reproducing program 72d, etc.

The communication program 72a is a program for executing the normal talk communication processing and the PTT communication processing as described above. The recording program 72b is a program for recording voice data of voices during the PTT communication, and creating the voice file 50 as shown in FIG. 4(A) in the flash memory 18. Although a description in detail is omitted, time information is stored together with the voice data in this embodiment. Here, the time information is information of the absolute time from the start of recording the PTT communication. The absolute time is evaluated from the current time acquired from the clock circuit 38. For example, the current time at a start of recording (record starting time) is recorded, and from the difference between it and the current time at a time of recording the voice data, the absolute time can be acquired. Here, storing the time information together with the voice data is merely one example, and a recording format of the voice data is decided depending on the reproduction decoder (reproducing program 72d) to be used.

Additionally, in this embodiment, the current time is acquired from the clock circuit 38 integrated in the mobile phone apparatus 10, but during the PTT communication, the mobile phone apparatus 10 is connected to the mobile phone network 104, and therefore, the current time may be acquired from the mobile phone network 104 (communication network).

The index creating program 72c is a program for creating the index file 52 as shown in FIG. 4(B) in the flash memory 18 in a case that voice data is recorded according to the recording program 72b. The reproducing program 72d is a program for reproducing all or a selected part of the voice data of the voice file. In this embodiment, the voice data is reproduced from the top of the voice file or the designated stating time, and the reproducing time (absolute time) is output.

Here, in a case that the reproducing program 72d calculates the absolute time from the amount of data of the voice data, it may store management information for managing the address (starting address or ending address) of the voice file 50 into which the voice data is recorded in place of the time information when the voice data is recorded. Thus, when a reproduction starting time (absolute time) is designated in reproducing, the reproduction time is calculated from the amount of data, and from the designated absolute time, reproducing the voice data is started, and the time information (absolute time) is output.

Although illustration is omitted, the information processing program includes programs of other functions. Example is a program for executing a dictionary function, a clock/calendar function, a calculator function, a voice recorder function, etc. Furthermore, programs for generating various screens (60, 62) as described above, and displaying the generated screens on the LCD monitor 30 are also stored. In addition, a program for outputting a sound (music) necessary for a mobile phone apparatus 30 such as an incoming call tone, etc. is also recorded.

In the data memory area 74, a voice data buffer 74a is provided. In addition, in the data memory area 74, selected speaker data 74b is stored.

The voice data buffer 74a is an area for temporarily storing voice data corresponding to the speech, and is erased after the voice data is recorded in the flash memory 18. Here, the speech is voices of the user of the own machine or other machines. The selected speaker data 74b is data of the identifying information of the selected speaker in a case that the selected speaker reproduction is executed.

Although illustration is omitted, in the data memory area 74, image data, for generating the above-described screen (60, 62), sound data, etc. are also stored, and counters (timer), flags, etc. required for execution of the information processing program are also provided.

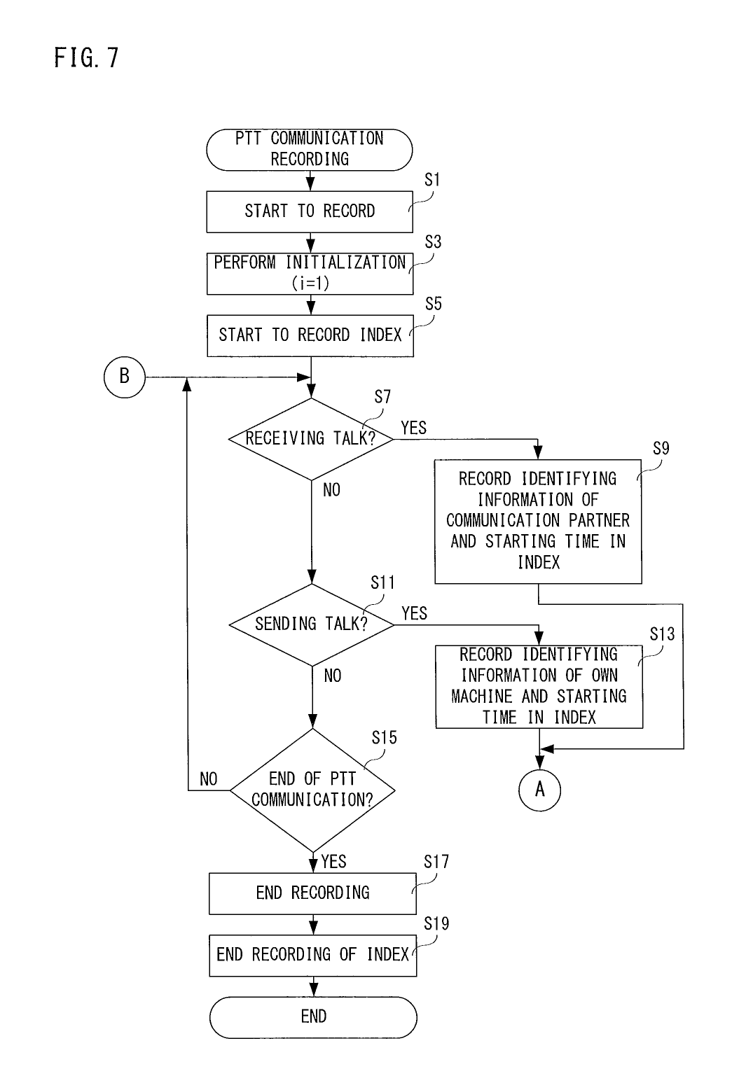

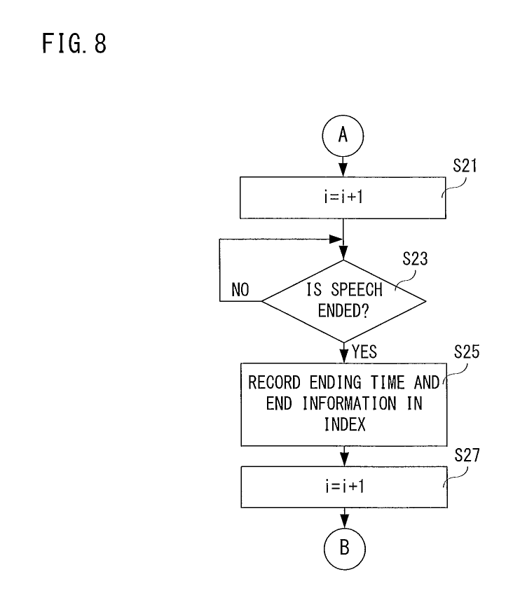

Each of FIG. 7 and FIG. 8 is a flowchart of PTT communication recording processing by the CPU 12 shown in FIG. 1. When the clear/memo key 20d is pushed during the PTT communication, the CPU 12 starts the PTT communication recording processing, and starts to record in a step S1 as shown in FIG. 7. That is, recording voice data of the speeches (sending talk or receiving talk) during the PTT communication and time information about the absolute time are started. In a next step S3, a variable i is initialized (i=1, here). The variable i is a variable for identifying the index number (line number). Hereafter, the variable i is a variable for identifying the index number (line number).

In a next step S5, recording (creating) the index is started. Here, recording the first line (i=1) of the index is started. Then, in a step S7, it is determined whether a receiving talk or not. More specifically, the CPU 12 determines whether or not receiving a voice packet from the mobile phone apparatus 10 of the communication partner (other machine) is started. If “YES” in the step S7, that is, if a receiving talk, the identifying information of the communication partner and the starting time of the speech of the communication partner are recorded in the i-th line of the index in a step S9, and the process proceeds to a step S21 shown in FIG. 8. Here, the identifying information of the communication partner is recorded in the header of the voice packet. Furthermore, the starting time is recorded by converting the time data of the current time acquired from the clock circuit 38 into data of the absolute time from the start of recording. This holds true for the description below. For example, the CPU 12 stores the record starting time, and store the difference between the record starting time and the current time at a start of receiving as an absolute time.

Furthermore, if “NO” in the step S7, that is, if not a receiving talk, it is determined whether a sending talk or not in a step S11. More specifically, the CPU 12 determines whether or not the off-hook key 20b of the own machine is turned on (the speech starts to be sent). If “YES” in the step S11, that is, if a sending talk, the identifying information of the own machine and the starting time of the speech of the user of the own machine are recorded in the i-th line of the index in a step S13, and the process proceeds to the step S21. Here, the identifying information of the own machine is recorded in the ROM 16. Furthermore, for example, the CPU 12 stores the difference between the record starting time and the current time at the start of the sending as an absolute time.

However, if “NO” in the step S11, that is, if not a sending talk, it is determined whether or not an end of the PTT communication in a step S15. That is, the CPU 12 determines whether or not the on-hook key 20c of the own machine is pushed. If “NO” in the step S15, that is, if not an end of the PTT communication, the process returns to the step S7 as it is. On the other hand, if “YES” in the step S15, that is, if an end of the PTT communication, the recording is ended in a step S17, the recording of the index is ended in a step S19, and the PTT communication recording processing is ended.

As shown in FIG. 8, in the step S21, the variable i is added by 1 (i=i+1). That is, recording the index in a next line is started. Then, in a step S23, it is determined whether or not the speech is ended. That is, the CPU 12 determines whether or not the off-hook key 20b of the own machine is released, or whether or not an output of the analogue voice signal corresponding to the voice data restored from the received voice packet is ended.

If “NO” in the step S23, that is, if the speech is not ended, the process returns to the same step S23. On the other hand, if “YES” in the step S23, that is, if the speech is ended, the ending time and the end information “END are recorded in the index in a step S25. Then, in a step S27, the variable i is added by 1, and the process returns to the step S7 shown in FIG. 7. Here, in the step S23, the CPU 12 acquires the current time data from the clock circuit 38, calculates the absolute time from the start of recording, and records the calculated absolute time in the i-th line of the index as an ending time.

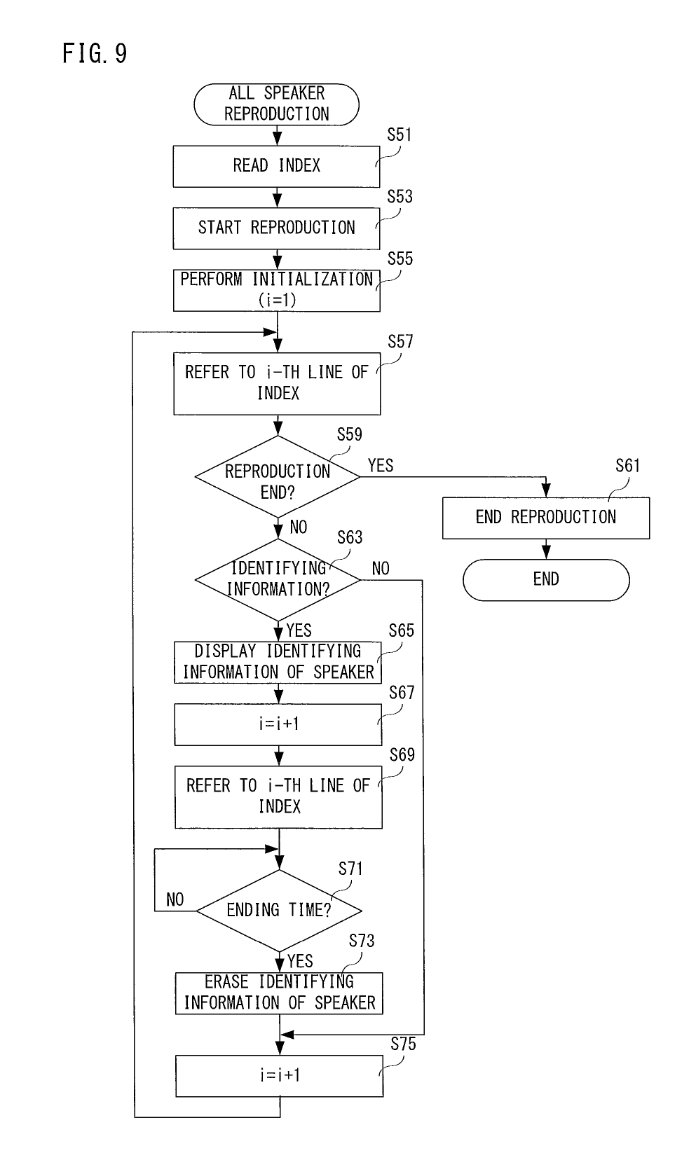

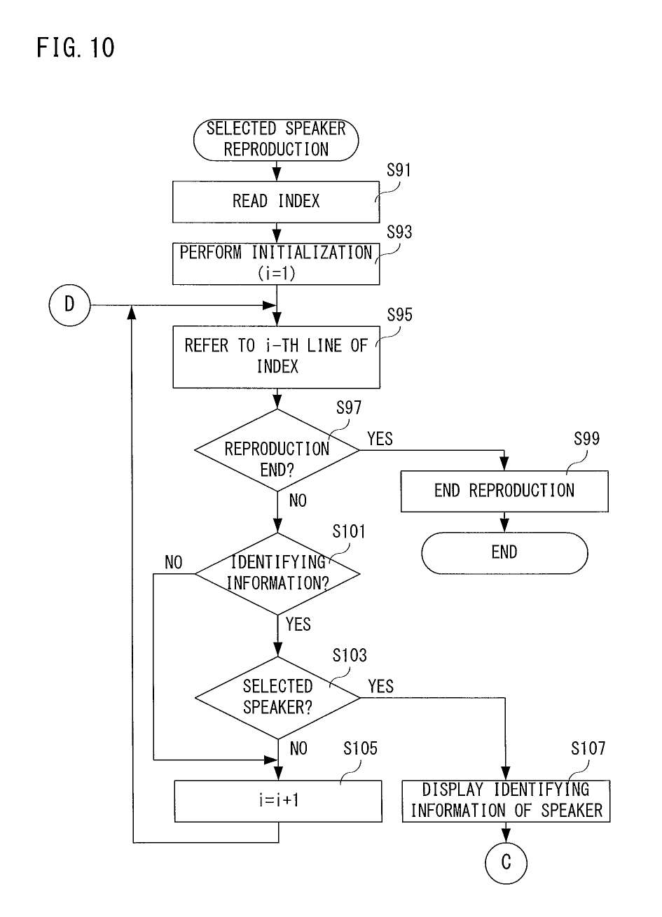

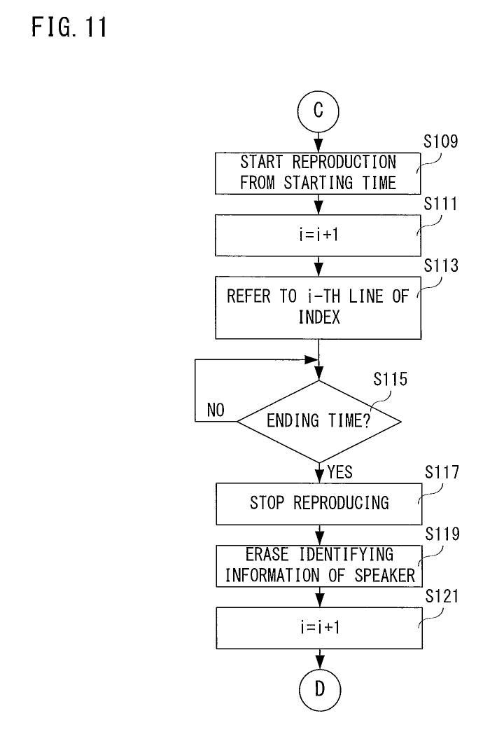

Next, a case that reproducing the recorded PTT communication is described, but as described above, the all speaker reproduction and the selected speaker reproduction are selectable, and they are different in a reproduction method, and therefore, they are separately explained. Here, FIG. 9 is a flowchart showing all speaker reproducing processing, and FIG. 10 and FIG. 11 are a flowchart showing selected speaker reproducing processing.

As shown in FIG. 9, when starting the all speaker selecting processing, the CPU 12 performs reading of the index in a step S51. Here, the CPU 12 loads the index file 52 stored in the flash memory 18 in a free area of the RAM 14. In a next step S53, reproducing is started. Here, the CPU 12 starts to read the voice data from the top of the voice file 50 stored in the flash memory 18, and applies the read voice data to the D/A converter 26. The D/A converter 26 converts the voice data into an analogue voice signal, and then outputs the same through the speaker 34. Furthermore, the CPU 12 acquires an absolute time (reproduction time) from the top of the voice data based on the time information attached to the voice data. This holds true for a case that voice data reproducing processing is executed hereunder.

Although an explanation in detail is omitted, the absolute time (reproduction time) acquired in reproducing may be displayed on the LCD monitor 30.

In a next step S55, the variable i is initialized (i=1), and in a step S57, the i-th line of the read index is referred. For the first time around, the first line (top) of the index is referred. In a succeeding step S59, it is determined whether a reproduction end or not. Here, the CPU 12 determines whether or not there is an instruction of an reproduction end from the user, or whether or not reproducing all voice data is completed (the line number indicated by the variable i is above the number of lines of the index).

If “YES” in the step S59, that is, if a reproduction end, reproduction ending processing is executed in a step S61, that is, reading the voice data from the voice file 50 in the flash memory 18 is ended, and the all speaker reproduction is ended. On the other hand, if “NO” in the step S59, that is, if not a reproduction end, it is determined whether or not the identifying information is described in the i-th line of the index in a step S63.

If “NO” in the step S63, that is, if “END” is described in the i-th line of the index, the process proceeds to a step S75 as it is. On the other hand, if “YES” in the step S63, that is, if the identifying information is described in the i-th line of the index, the identifying information of the speaker (phone number) is displayed on the LCD monitor 30 in a step S65. Here, in a case that the designation is registered in correspondence with the phone number of the speaker in the address book stored in the mobile phone apparatus 10, the designation is displayed on the LCD monitor 30. That is, in a case that the designation is not registered in correspondence with the phone number in the address book, the identifying information (phone number) is displayed on the LCD monitor 30 as it is.

In a next step S67, the variable i is added by 1, and in a step S69, the i-th line of the index is referred. Then, in a step S71, it is determined whether an ending time or not. Here, it is determined whether or not the reproduction time (absolute time) acquired from the time information matches the ending time described in the i-th line of the index. That is, it is determined whether or not reproducing the speech of the speaker indicated by the identifying information described in the i−1-th line of the index is ended. If “NO” in the step S71, that is, if not the ending time, the process returns to the same step S71. On the other hand, if “YES” in the step S71, that is, if an ending time, the identifying information of the speaker is erased from the LCD monitor 30 in a step S73, the variable i is added by 1 in the step S75, and the process returns to the step S57.

Furthermore, when the selected speaker reproduction is selected to select a speaker (talker), the CPU 12 starts the selected speaker reproducing processing as shown in FIG. 10. The selected speaker reproducing processing is explained below, but the processing the same as that of the all speaker reproducing processing is simply described.

First, the CPU 12 reads the index in a step S91. In a next step S93, the variable i is initialized, and in a step S95, the i-th line of the index is referred. In a next step S97, it is determined whether a reproduction end or not. If “YES” in the step S97, the reproduction ending processing is executed in a step S99, and the selected speaker reproducing processing is ended. On the other hand, if “NO” in the step S97, that is, if not a reproduction end, it is determined whether or not the identifying information is described in the i-th line of the index in a step S101.

If “NO” in the step S101, the process proceeds to a step S105. On the other hand, if “YES” in the step S101, it is determined whether a selected speaker or not in a step S103. Here, the CPU 12 determines whether or not the identifying information described in the i-th line of the index is included in one or a plurality of identifying information indicated by the selected speaker data 74b.

If “NO” in the step S103, that is, if not the selected speaker, the variable i is added by one in a step S105, and the process returns to the step S95. On the other hand, if “YES” in the step S103, that is, if the selected speaker, the identifying information of the speaker is displayed on the LCD monitor 30 in a step S107, and reproduction is started from the starting time described in the i-th line of the index in a step S109 shown in FIG. 11. That is, the CPU 12 searches the voice file 50, and starts reproducing from the position (reproduction position) where the absolute time indicated by the time information added to the voice data matches with the starting time described in the i-th line of the index.

In a next step S111, the variable i is added by 1, and in a step S113, the i-th line of the index is referred. Succeedingly, in a step S115, it is determined whether an ending time or not. If “NO” in the step S115, the process returns to the same step S115. On the other hand, if “YES” in the step S115, the reproduction is stopped in a step S 117. That is, the CPU 12 stops reading the voice data from the voice file 50 in the flash memory 18. Then, the identifying information of the speaker is erased from the LCD monitor 30 in a step S119, the variable i is added by 1 in a step S121, and the process returns to the step S95 shown in FIG. 10.

According to this embodiment, identifying information about the speaker and the starting time or the ending time of the speech are recorded as well as the voices during the PTT communication are recorded, and therefore, it is possible to easily determine when a speech is made and who makes a speech as to a series of voices during the PTT communication. Furthermore, it is possible to reproduce only the speeches by a selected desired speaker. Moreover, the identifying information of the speaker is displayed on the LCD monitor at reproduction, and therefore, it is possible to easily know the speaker of the speech during reproducing.

Here, in this embodiment, the voices during the PTT communication are recorded, but in the PTT communication, it may be possible to send and receive other contents such as videos (images), sound (music), letters except for the voices. Accordingly, in place of the voices, or together with the voices, other contents may be recorded or reproduced (displayed).

Furthermore, in this embodiment, only a case that a mobile phone apparatus is used as an electronic device is described, but a digital transceiver may be used as another embodiment.

In addition, in this embodiment, the voice data corresponding to the voices during the PTT communication is recorded in an AAC formats in the flash memory, but there is no need of being restricted thereto. For example, this may be recorded in other formats, such as MP3 (MPEG Audio Layer-3), WMA (Windows (registered trademark) Media Audio), etc. For example, in a case that the voice data is recorded in the MP3 format, the header has a relatively large capacity, so that the index file may be recorded in the header.

Furthermore, in this embodiment, an off-hook key is utilized as a PTT button, but a dedicated button or key may be provided.

Moreover, in this embodiment, when voice data is reproduced, identifying information about the speaker of the speech (voice) corresponding to the voice data is displayed, but as well as the identifying information, the length (ending time-starting time) of the sending talk or the absolute time of the sending talk, or both of them may be displayed.

Additionally, in this embodiment, a description is omitted, but the voice file and the index file corresponding thereto are generated every PTT communication. Accordingly, in a case of reproducing, a voice file to be reproduced is selected, and a reproduction mode is selected.

In addition, in this embodiment, the phone number of the mobile phone apparatus is used as identifying information, and therefore, in reproducing, the designation registered in the address book or the phone book so as to be brought into correspondence with the phone number is displayed on the LCD monitor. Accordingly, in a case that the information equivalent to the phone number is used as identifying information, if the information equivalent to the phone number is also brought into correspondence with the phone number and the designations registered in the address book, the designation can be displayed on the LCD monitor according to the address book, etc.

Although the present invention has been described and illustrated in detail, it is clearly understood that the same is by way of illustration and example only and is not to be taken by way of limitation, the spirit and scope of the present invention being limited only by the terms of the appended claims.

### EXPLANATION OF REFERENCE CHARACTERS

10 . . . mobile phone apparatus (electronic device)

12 . . . CPU

14 . . . RAM

16 . . . ROM

18 . . . flash memory

20 . . . key input device

22 . . . LCD driver

28 . . . transmitter/receiver circuit

32 . . . microphone

34 . . . loudspeaker

38 . . . clock circuit

1. An electronic device making a half-duplex communication among one or a plurality of communication partner's devices, comprising:
a communicator which sends and receives a content to and from said communication partner's device, and
an information storage which stores said content, identifying information about a sender of said content and a sent time in a storage when said content is sent to said communication partner's device by said communicator, and stores said content, identifying information about a sender of said content and a received time in said storage when said content is received from said communication partner's device by said communicator.

2. An electronic device according to claim 1, further comprising:
a displayer;
a content reproducer which reproduces a content stored in said storage; and
an identifying information displayer which displays identifying information about at least the sender of said content on said displayer when said content is reproduced by said content reproducer.

3. An electronic device according to claim 2, wherein said content reproducer reproduces contents stored in said storage according to a temporal order of said sent time and said received time.

4. An electronic device according to claim 2 further comprising:
an identifying information selector which selects the identifying information about said sender of said content, wherein
said content reproducer reproduces the content stored in said storage together with the identifying information about the sender of said content selected by said identifying information selector.

5. An electronic device according to claim 1, wherein the identifying information about said sender of said content is a phone number.

6. An electronic device according to claim 1, wherein said information storage stores the identifying information about the sender of said content and said sent time or said received time that are stored together with said content as an index file including them in said storage.

7. An electronic device according to claim 1, wherein said information storage stores the identifying information about the sender of said content and said sent time or said received time that are stored together with said content as header information of said content.

8. An electronic device according to claim 1, wherein said sent time and said received time are an absolute time from a start of recording said content.

9. A storage medium storing an information processing program of an electronic device making a half-duplex communication among one or a plurality of communication partner's devices,
said information processing program causes a computer of said electronic device to execute:
a communicating step for sending and receiving a content to and from said communication partner's device, and
an information storing step for storing said content, identifying information about a sender of said content and a sent time in a storage when said content is sent to said communication partner's device by said communicating step, and stores said content, identifying information about a sender of said content and a received time in said storage when said content is received from said communication partner's device by said communicating step.

10. An information processing method of an electronic device making a half-duplex communication among one or a plurality of communication partner's devices, including steps of:
(a) sending and receiving a content to and from said communication partner's device, and
(b) storing said content, identifying information about a sender of said content and a sent time in a storage when said content is sent to said communication partner's device by said step (a), and stores said content, identifying information about a sender of said content and a received time in said storage when said content is received from said communication partner's device by said step (a).
